(19) United States
(12) Patent Application Publication
(10) Pub. No.: US 2014/0123048 A1
(43) Pub. Date: May 1, 2014

(54) APPARATUS FOR A VIRTUAL INPUT DEVICE FOR A MOBILE COMPUTING DEVICE AND THE METHOD THEREIN

(71) Applicant: Kanit Bodipat, Bangkok (TH)

(72) Inventor: Kanit Bodipat, Bangkok (TH)

(21) Appl. No.: 13/699,882

(22) PCT Filed: May 24, 2011
(86) PCT No.: PCT/TH2011/000015

§ 371 Date: Jan. 10, 2014

(51) Int. Cl. G06F 3/0488

(52) U.S. Cl. CPC G06F 3/04886
USPC 715/773

(57) ABSTRACT

An apparatus for a virtual input device for a mobile computing device is disclosed. In order to achieve higher throughput and accuracy of a virtual input system, the present invention is primarily characterized in that a system detects movement of a user's fingers on a work surface through at least one wearable sensor which wirelessly transmits the optical signal from the coupled transmitter to the optical receiver for processing and determining the corresponding user's input based on the predefined algorithm or pattern.

### FIELD OF INVENTION

The present invention relates generally to the field of keyboards and more particularly to virtual keyboards for mobile computing devices.

### BACKGROUND OF INVENTION

A keyboard of a hand-held device as disclosed in Prior Art, U.S. Pat. No. 6,266,048 B1 is known. The device as indicated in U.S. Pat. No. 6,266,048 B1 is comprised of a virtual display and a virtual keyboard projected from the attached personal digital assistant by means of a Digital Micro mirror Display with two lasers sensors projected across the said virtual keyboard. The accuracy of the input is not very high due to the fact that the accuracy of this device depends substantially on the interception of the laser beams over a virtual key of the said virtual keyboard.

Another keyboard is disclosed in U.S. Pat. No. 6,650,318 B1. The said device is comprised of an optically generated image of a data input device, a sensor operative to sense the action performed on the at least one input zone, and a processor in communication with the sensor operative to process the signals for performing an operation associated with the at least one input zone. The accuracy of the input also depends substantially on the detection of light reflected from an object within a silhouette of the image.

Another keyboard is disclosed in U.S. Pat. No. 7,215,327 B2. The said device includes a first laser emitter, a second laser emitter, and a laser receiver. The first laser emitter performs a surface scan to generate the patterns of the keyboard. The second laser emitter simultaneously generates a first reflective beam and a second reflective beam when the user enters input using the virtual keyboard. Finally, the laser receiver receives the first and second reflective beams, thereby obtaining the signals entered by the user. Hence, the accuracy of this input device also depends substantially on the detection of the reflective beams.

Another type of keyboard which does not rely on interception or reflection is disclosed in U.S. Pat. No. 6,097,373. The said keyboard is comprised of a laser pointer mounted on an adjustable headband for directing a collimated beam onto a laser keyboard defined by an array of photo sensors that are intended to be illuminated by an array of photo sensors. This device is not comfortable and convenient for every task, particularly tasks which require speed and accuracy.

Accordingly, the object of the present invention is to solve the above described problems by providing a method and an Apparatus therein for a virtual input device for a mobile computing device which can achieve higher throughput and accuracy and still be economical and convenient for users.

### SUMMARY OF INVENTION

In view of the foregoing, the present invention provides an apparatus for a virtual input device for a mobile computing device comprising

An emitter for optically generating an image of a data input device, said image comprising at least one input area actuable by an action performed thereon by a user;

A sensor attached to said user for sensing the action performed on the input;

An optical transmitter coupled to the said sensor having a power supply for generating at least two optical signals having different levels of brightness and corresponding to the created pressure and the position of said action;

An optical receiver configured to detect the optical signal generated from the optical transmitter and transmitting the signal to a processing device for determining said user's input based on the comparison of levels of brightness of the generated signals and second comparison of the signals and at least one predefined pattern of signal stored in a memory unit of the processing device. In some aspects the signal can also be generated based on a predefined functionality, historical information of at least one previous user's action or a combination thereof

The corresponding method has the following steps. First, the emitter projects a virtual input device on the work surface. A user performs an action on said input area. The sensor senses the action performed on the input area by a user and notifies the coupled optical transmitter to transmit at least two optical signals having different levels of brightness and corresponding to the created pressure and position of said action. In some aspects the signal can also be generated based on a predefined functionality, historical information of at least one previous user's action or a combination thereof. The strength of said optical signals depend on the level of pressure created by the said action. The optical receiver then detects the signal and transmits the detected signal to the processing unit wherein the determination of a user's input is based on the first comparison of levels of brightness of the generated signals and the second comparison of the signals and at least one predefined pattern of signal stored in a memory unit of the processing device.

In a related aspect, the image of a data input device is an image of a keyboard. The said sensor may further comprise a plurality of sub sensors in the form of finger covers allowing the user to type in the same manner as that on a regular physical keyboard. Preferably, and the optical receiver is configured to take advantage of the built-in camera in regular cellphones or PDA for the purpose of detection of the optical signal

In some cases, said optical receiver receives a plurality of signals before it processes and determines the input and the determination of a user's input is based on a plurality of predefined patterns of optical signals. This would ensure the accuracy of the input to the extent required by users.

For a better understanding of the preferred embodiment and to show how it may be performed, it will now be described in more detail by way of example only, with reference to the accompanying drawings.

### BRIEF DESCRIPTION OF THE DRAWINGS

FIG. 1 is a diagram depicting a device displaying a keyboard guide according to one embodiment of the present invention.

FIG. 2 is an example of a wearable sensor coupled with an optical transmitter according to one embodiment of the present invention.

FIG. 3 is a flow chart of an input method for a mobile computing device of an embodiment of the present invention.

### DETAILED DESCRIPTIONS OF THE PREFERRED EMBODIMENT

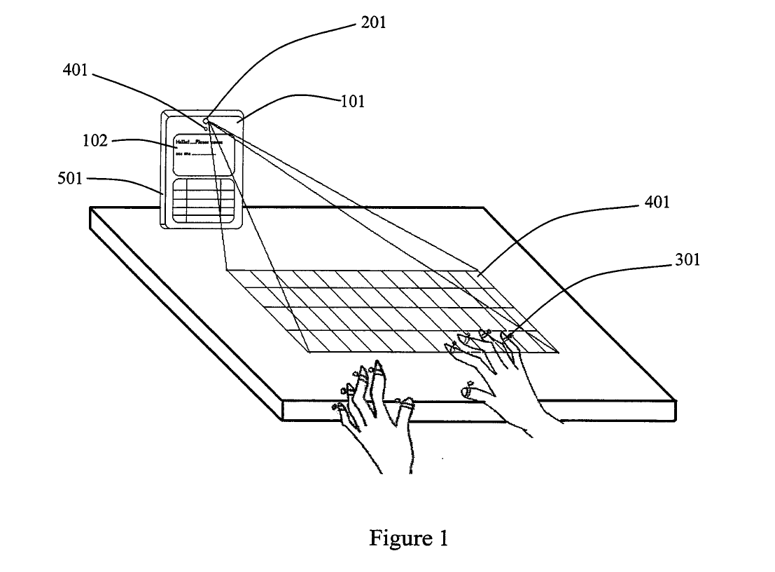

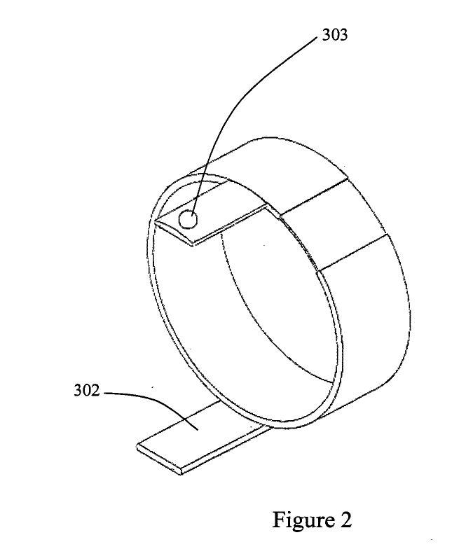

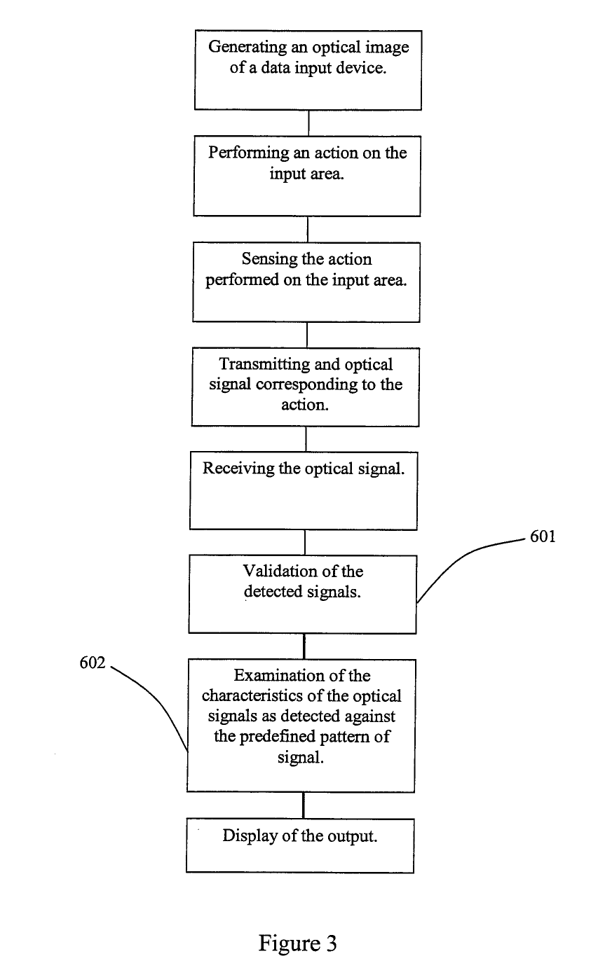

With simultaneous reference to FIGS. 1, 2 and 3, the invention discloses a cellphone or PDA 101 and the wearable finger covers 301. Each cover comprises a sensor 302 and a coupled optical transmitter 303. The emitter 201 positioned on the cellphone or PDA 101 projects the virtual input keyboard or other input device 401.

When the user performs an action on the projected keyboard or other input areas, the sensors 302 senses the said action and automatically notifies the optical transmitter 303 to generate at least two optical signals having different levels of brightness and corresponding to the created pressure and position of said action. The strength or the light intensity of the optical signals depend on the level of pressure created by the said action. The optical signals are then detected by the optical receiver 401 which transmits the signals as detected to a processing device 501 for determining the user's input. The determination includes the examination of the validity of the signals 601 based on the comparison of the levels of brightness of signals and subsequent examination of the characteristics of the optical signals 602 as detected against the predefined pattern of signal stored in a memory unit of the processing device 501. The output of the determination is shown on the display 102 of cell phone or PDA 101.

It will be appreciated by persons skilled in the art that the present invention is not limited by what has been particularly shown and described hereinabove. Rather the scope of the present invention includes both combinations and sub-combinations of the features described hereinabove as well as modifications and variations thereof which would occur to a person of skill in the art upon reading the foregoing description and which are not in the prior art.

What is claimed is:

1. An apparatus for a virtual input device for a mobile computing device comprising
An emitter for optically generating an image of a data input device, said image comprising at least one input area actuable by an action performed thereon by a user;
A sensor attached to said user for sensing said action performed on the input;
An optical transmitter coupled to said sensor having a power supply for generating an optical signal corresponding to the created pressure and the position of said action;
An optical receiver configured to detect said optical signal generated from the optical transmitter and transmitting the signal to a processing device for determining said user's input;
Wherein the determination of a user's input is based on the comparison between said signal and at least one predefined pattern of signal stored in a memory unit of the processing device.

2. An Apparatus for a virtual input device for a mobile computing device as recited in claim 1 wherein the said optical receiver detects a plurality of input signals and the determination of the corresponding user's input is based on the comparison between said input signals and a plurality of predefined patterns of optical signals.

3. An Apparatus for a virtual input device for a mobile computing device as recited in claim 1 wherein strength of said optical signal depends on the level of pressure created by the said action.

4. An Apparatus for a virtual input device for a mobile computing device as recited in any of the preceding claims wherein the image of a data input device is an image of a keyboard.

5. An Apparatus for a virtual input device for a mobile computing device as recited in any of the preceding claims wherein the optical transmitter comprises Light Emitting Diode capable of generating infrared.

6. An Apparatus for a virtual input device for a mobile computing device as recited in any of the preceding claims wherein the optical receiver comprises a camera.

7. An Apparatus for a virtual input device for a mobile computing device as recited in any of the preceding claims wherein the sensor is further comprised of a plurality of sub sensors.

8. An Apparatus for a virtual input device for a mobile computing device as recited in any of the preceding claims wherein said sub sensors are in the form of wearable finger covers.

9. Input method for a mobile computing device comprising the steps of:
Generating an optical image of a data input device, said image comprising at least one input area actuable by an action performed thereon by a user;
Performing an action on said input area;
Sensing the action performed on the input area by a user;
Generating an optical signal corresponding to the position of said action;
Transmitting said optical signal;
Receiving said optical signal; and
Processing said signal and determining a user's input based on the comparison between said signal and at least one predefined pattern of signal.

10. Input method for a mobile computing device as recited in claim 8 further comprising:
Generating a plurality of optical signals;
Receiving a plurality of optical signals.

11. Input method for a mobile computing device as recited in claim 8 or 9 wherein said signal is transmitted by means of an infrared.

12. An apparatus for a virtual input device for a mobile computing device comprising
an emitter for optically generating an image of a data input device, said image comprising at least one input area actuable by an action performed thereon by a user;
a sensor attached to said user for sensing said action performed on the input;
an optical transmitter coupled to said sensor having a power supply for generating at least two optical signals having different levels of brightness and corresponding to the created pressure and the position of said action;
an optical receiver configured to detect said optical signal generated from the optical transmitter and transmitting the signal to a processing device for determining said user's input;
wherein the determination of a user's input is based on the first comparison of levels of brightness of the generated signals and second comparison of the signal and at least one predefined pattern of signal stored in a memory unit of the processing device.

13. An apparatus for a virtual input device for a mobile computing device as recited in claim 1, wherein strength of said optical signal depends on the level of pressure created by the said action.

14. An apparatus for a virtual input device for a mobile computing device as recited in claim 1, wherein the image of a data input device is an image of a keyboard.

15. An apparatus for a virtual input device for a mobile computing device as recited in claim 1, wherein the optical transmitter comprises a light emitting diode capable of generating infrared.

16. An apparatus for a virtual input device for a mobile computing device as recited claim 1, wherein the optical receiver comprises a camera.

17. An apparatus for a virtual input device for a mobile computing device as recited in claim 1, wherein the sensor is further comprised of a plurality of sub sensors.

18. An apparatus for a virtual input device for a mobile computing device as recited in claim 6, wherein said sub sensors are in the form of wearable finger covers.

19. Input method for a mobile computing device comprising the steps of:
generating an optical image of a data input device, said image comprising at least one input area actuable by an action performed thereon by a user;
performing an action on said input area;
sensing the action performed on the input area by a user;
generating at least two optical signals corresponding to the created pressure and position of said action;
transmitting said optical signals;
receiving said optical signals; and
processing said signal and determining a user's input based on a first comparison of levels of brightness of the generated signals and a second comparison of the signals and at least one predefined pattern of signal.

20. Input method for a mobile computing device as recited in claim 8, wherein said signal is transmitted by means of an infrared.
